(19) United States
(12) Patent Application Publication
(10) Pub. No.: US 2019/0137770 A1
(43) Pub. Date: May 9, 2019

(54) DISPLAY SYSTEM AND METHOD THEREOF

(71) Applicants: Mindtronic AI Co.,Ltd., Grand Cayman (KY); Shanghai XPT Technology Limited, Shanghai City (CN)

(72) Inventors: Mu-Jen Huang, Taipei City (TW); Ya-Li Tai, Taoyuan City (TW); Yu-Sian Jiang, Kaohsiung City (TW)

(21) Appl. No.: 16/184,970

(22) Filed: Nov. 8, 2018

Related U.S. Application Data
(60) Provisional application No. 62/583,524, filed on Nov. 9, 2017.

(30) Foreign Application Priority Data
Jun. 20, 2018 (TW) 107121103

(51) Int. Cl. G02B 27/22; G06T 7/70; G06T 7/55; G06F 3/01; G06T 15/20; G02B 27/01; G01C 21/36

(52) U.S. Cl. CPC G02B 27/225; G06T 7/70; G06T 7/55; G06F 3/012; G06F 3/013; G06T 15/20; G06K 9/00268; G02B 27/0179; G01C 21/3635; G06T 2207/30201; G06T 2207/20221; G06T 2207/10028; G02B 27/0101

(57) ABSTRACT

A display system includes an image capturing module, a display device and a processing unit. The image capturing module captures a head image of a viewer. The processing unit performs the following instructions. A head vector is computed based on the head image, where the head vector includes the distance information between the viewer and the display device. A left eye position and a right eye position of the viewer is computed based on a facial image of the viewer. A left eye field of view, a right eye field of view and a binocular stereoscopic field of view are generated based on the head vector, the left eye position and the right eye position. The display device displays an image in the binocular field of view.

### CROSS REFERENCE TO RELATED APPLICATIONS

This patent application claims the benefit of U.S. provisional patent application Ser. No. 62/583,524, which was filed on Nov. 9, 2017, and incorporated herein by reference in its entirety.

### BACKGROUND OF THE INVENTION

### 1. Field of the Invention

The invention relates to a display system and a method, and more particularly, to a display system and a method of displaying images on the limited range of a display device.

### 2. Description of the Prior Art

Human's field of view has a limited range of visual field (including a horizontal visual angle and a vertical range visual angle). To expand visual fields, we have to constantly change viewing angles as well as viewing directions. For example, assuming a vehicle is parked in front of a viewer in the real world, from the place where the viewer stands, he/she may only see the front side of the car because of the limited scope of the field of view. However, when the viewer moves the position to the right where he/she can view the same vehicle from the right (to the left), the viewer can therefore see a partial front side and a partial lateral side of the vehicle car. That is, by changing the viewing angle and direction the field of view can be expanded indefinitely in the real world.

Nonetheless, the situation would be different when it comes to images displayed on a display device. Given the limited size of display devices, images can only be presented in conforming with the size of a display device. Consequently, the information can be displayed is also restricted.

Besides, conventional display adopts a perspective transform to flat a 3D object into a 2D format. However, images presented on conventional screens are static. That is, an image remains unchanged no matter where the viewer is. The viewing experience is different to that in the real world.

### SUMMARY OF THE INVENTION

According to one aspect of the present disclosure, a display system is provided. The display system includes an image capturing module, a processing unit, and a display device. The image capturing module is configured to capture a head image of a viewer. The processing unit is coupled to the image capturing module and configured to perform the following instructions. A head vector is computed based on the head image. A left eye position and a right eye position are computed based on a face image of the viewer. A left eye field of view and a right eye field of view are generated based on the head vector, the left eye position and the right eye position. A binocular stereoscopic field of view is generated based on the left eye field of view and the right eye field of view. The display device coupled to the processing unit, and configured to display an image in the binocular stereoscopic field of view.

According to another aspect of the present disclosure, a display system is provided. The display system includes an image capturing module, a processing unit, and a display device. The image capturing unit is configured to capture a first head image of the viewer at a first position and a second head image of the viewer at a second position. The processing unit is coupled to the image capturing module and configured to perform the following instructions. A first head vector of the viewer at the first position is computed based on the first head image. A first facial image of the viewer is obtained and a first left eye position and a first right eye position of the viewer are computed based on the first facial image. A first left eye field of view, a first right eye field of view and a first binocular stereoscopic field of view are generated based on the first left eye position, the first right eye position and the first head vector. A second head vector of the viewer at the second position is computed based on the second head image. A second facial image of the viewer is obtained and a second left eye position and a second right eye position of the viewer are compute based on the second facial image. A second left eye field of view, a second right eye field of view and a second binocular stereoscopic field of view are generated, based on the second left eye position, the second right eye position and the second head vector. The display device displays a first image in the first binocular stereoscopic field of view when the viewer is at the first position; and displays a second image in the second binocular stereoscopic field of view when the viewer is at the second position.

According to yet another aspect of the present disclosure, a method for displaying a navigation map including geographic data and information is provided. The method includes the following actions. The geographic data and information are stored in a database. A first image including a first geographic data and information is displayed, by the display device, when the viewer is at the first position. A second image including a second geographic data and information is displayed, by the display device, upon determining that the viewer has moved from the first position to a second position.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an intelligent vehicle according to an embodiment of the present invention.

FIG. 2 is a functional block diagram of a displaying system according to the embodiment of the invention.

FIG. 3 is a diagram of the displaying system according to the embodiment of the invention.

FIG. 4 is a diagram illustrating a head image of a viewer captured by an image capturing module according to the embodiment of the invention.

FIG. 5 is a diagram illustrating a processing unit acquiring a facial image of the viewer according to the embodiment of the invention.

FIG. 6 is a flow diagram of a displaying method according to the embodiment of the invention.

FIG. 7A is a top view of the displaying system as shown in FIG. 3 according to the embodiment of the invention.

FIG. 7B is a diagram illustrating the viewer viewing an image on the displaying system from the left according to the embodiment of the invention.

FIG. 7C is a diagram illustrating the viewer viewing an image on the displaying system from the right according to the embodiment of the invention.

FIG. 8 is a side view of the displaying system as shown in FIG. 3 according to the embodiment of the invention.

FIG. 9 is a top view illustrating the displaying system zooming in on an image according the embodiment of the invention.

FIG. 10 is side view illustrating the displaying system zooming in on the image according to the embodiment of the invention.

FIG. 11A, FIG. 11B, and FIG. 11C are flow diagrams of displaying methods for the displaying system varying displaying perspective in accordance with the movement of the viewer relative to the displaying system according to the embodiment of the invention.

FIG. 12 is a diagram illustrating a navigation map graphic displayed by the displaying system as shown in FIG. 7B according to the embodiment of the invention.

FIG. 13 is a diagram illustrating the navigation map graphic displayed by the displaying system as shown in FIG. 7C according to the embodiment of the invention.

FIG. 14 is a diagram illustrating a displaying method and displayed graphic content adjusted in accordance with variation of a sightline of the viewer according to the embodiment of the invention.

### DETAILED DESCRIPTION

In this disclosure, a directional terminology, such as “top”, “bottom”, “front”, “back”, “left”, “right”, is used with reference to the orientation of the Figure(s) being described. However, the components of the present disclosure may be positioned in several different orientations. As such, the directional terminology is used for illustration purposes only. Accordingly, the drawings and descriptions will be regarded as illustrative in nature and not as restrictive.

In the present disclosure, a display system and a method for displaying images on a display system are provided to generate an image according to a sightline of a viewer. Via the display system, an appearance of the object presented to the viewer may vary with the sightline of the viewer as if the object was observed in the real world, which gives the viewer a more realistic user experience. In addition, various displayed images may be provided according to various sightlines of the viewer so as to expand the field of view of the viewer.

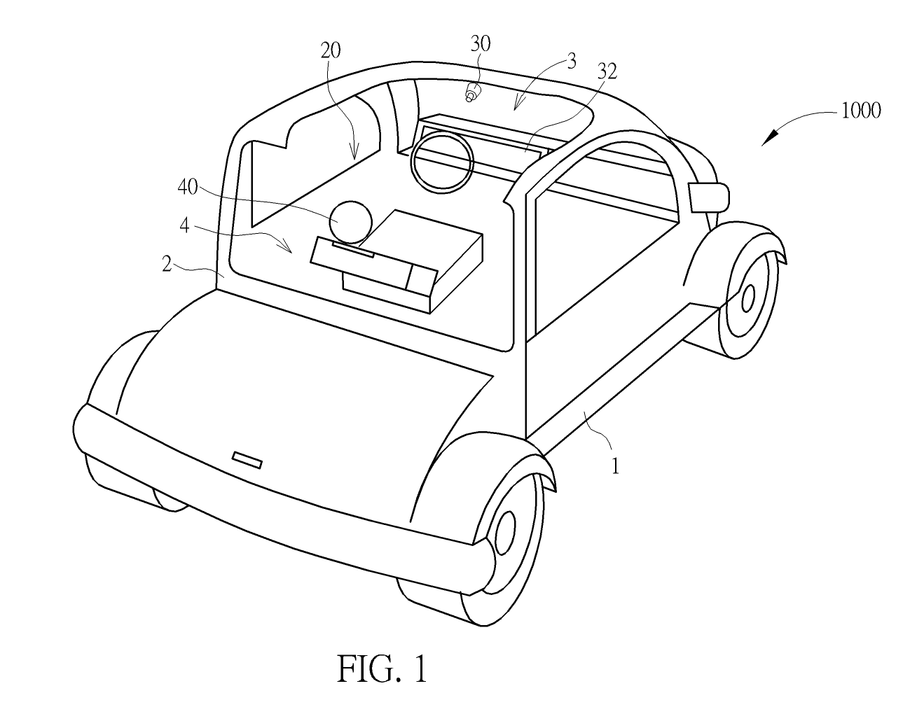

FIG. 1 is a schematic diagram of a display system 3 implemented in an intelligent vehicle 1000 according to an embodiment of the present disclosure. The intelligent vehicle 1000 includes a chassis 1, a frame 2, and the display system 3. The frame 2 is disposed on the chassis 1, and has a cabin 20 for the driver 4 and passengers (not shown). It should be noticed that, in some other embodiments, the display system may be implemented in any apparatus, such as a portable device.

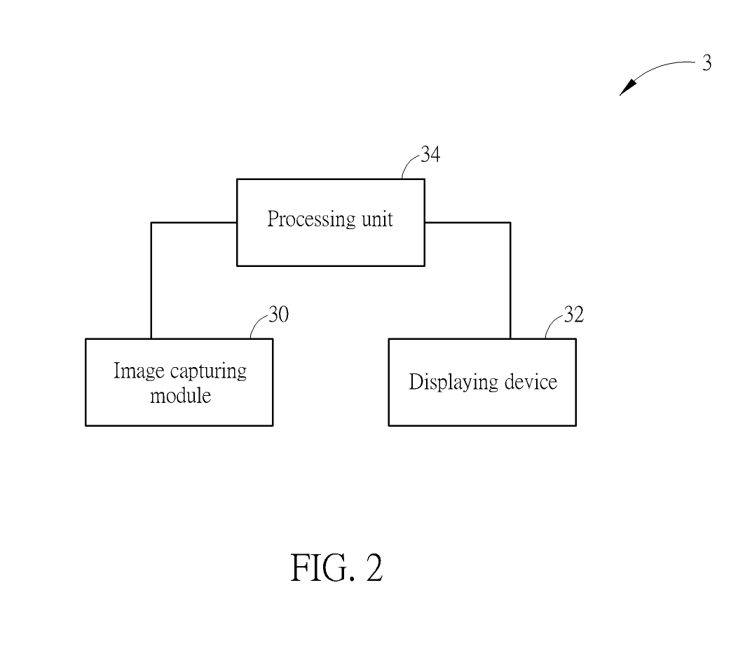

FIG. 2 is a schematic block diagram of a display system 3 according to an embodiment of the present disclosure. As shown in FIG. 2, the display system 3 includes an image capturing module 30, a displaying device 32 and a processing unit 34. In this embodiment, the display system 3 is implemented in an intelligent vehicle (e.g., 1000 as shown in FIG. 1). The image capturing module 30 may be disposed inside (e.g., in a cabin 20 as shown in FIG. 1). The image capturing module 30 is configured to capture a viewer's head images. In one implementation, the image capturing module 30 may be, but not limited to, a camera or any device capable of capturing images.

The displaying device 32 is disposed inside the cabin 20. The display device is configured to display a fused image. The displaying device 32 may be, but not limited to, a digital vehicle instrument cluster, a central console panel, or a head-up display.

The processing unit 34 is coupled to the image capturing module 30 and the displaying device 32. The processing unit 34 may be an intelligent hardware device, such as a central processing unit (CPU), a microcontroller, or an ASIC. The processing unit 34 may process data and instructions. In this embodiment, the processing unit 34 is an automotive electronic control unit (ECU).

As previously mentioned, conventional display devices present images dully. An image displayed on a conventional displayer will not change in any viewing direction. From viewers' perspectives, the field of view is constant. On the other hand, the image provided in accordance with the instant disclosure may change with different sightlines of a viewer. Therefore, a field of view of the viewer may be expanded even though the display area is fixed.

In the present disclosure, the images provided by the display system 3 may change with the sightline of the viewer. The displaying device 32 provides a visual effect that a 3D object is placed in a virtual space. Because of the visual effect, when viewing the 3D object on the displaying device 32, it feels that the 3D object is extended within virtual space. Therefore, the displaying device 32 may present any aspect of the 3D object as an image to the viewer as if it is a real object in the real world even though the displaying device 32 is a flat display device. Furthermore, content with different depths may also be displayed in the virtual space. Moreover, based on the sightline of the viewer, the same content (such as a map including geographic data and information) may be presented to the view in different ways or at different positions within the virtual space.

Conventionally, when a viewer is looking at a screen, given the size limitation, the screen can only present a navigation map having partial geographic data and neighborhood information to a viewer. For instance, the viewer can only see a limited range of a map on the screen. Roads and buildings are the edges of the screen are cut. In order to get further information, the viewer must manually either zoom in, zoom out, move or drag the map which is impossible and danger when the viewer is driving.

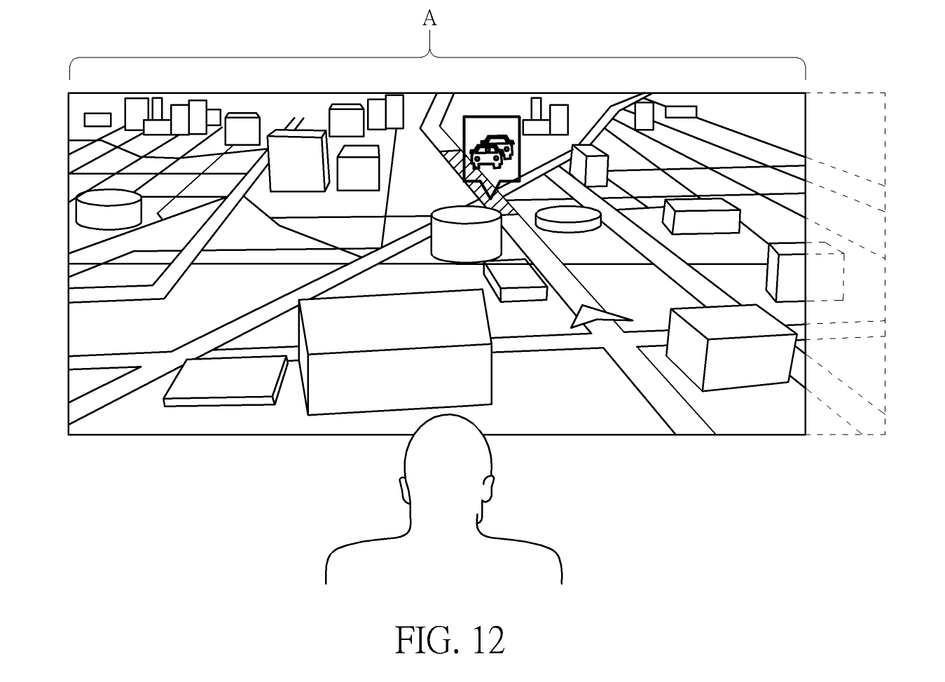

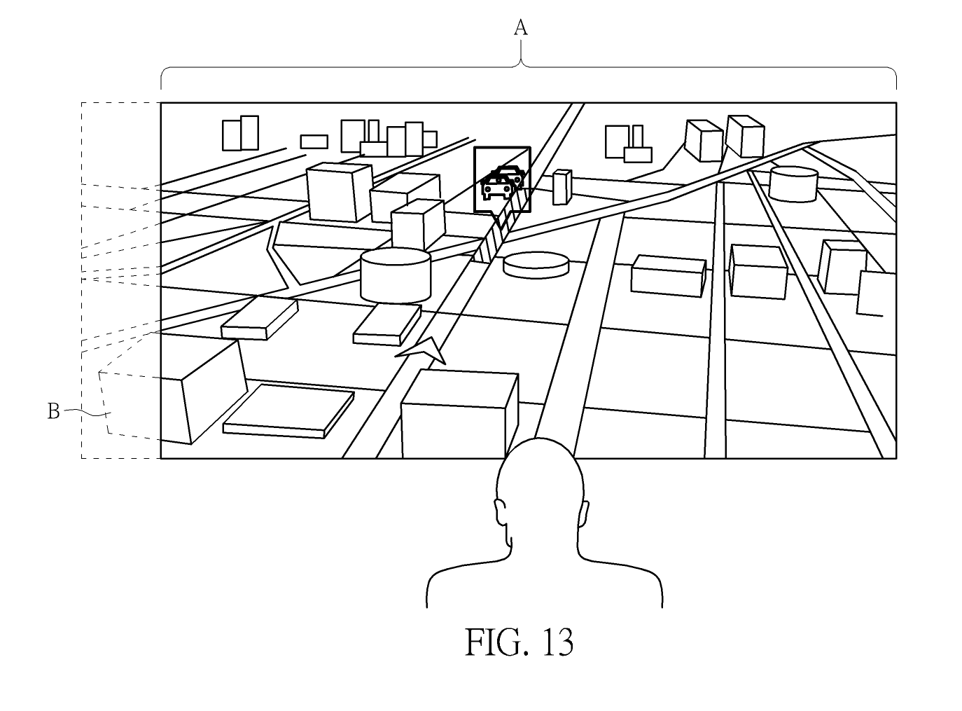

On the other hand, the display system 3 of the present disclosure comprehensively preserves the entire geographic data and neighborhood information. For instance, as shown in FIGS. 12 and 13, in the present disclosure the detail of the roads and buildings at the edges, though are not presented to the viewer from his/her current perspective (i.e. those presented to the viewer are framed in the solid-lines), are preserved (i.e. those in dot-lines).

In all, the display system 3 of the present disclosure determines the sightline of the viewer and change the displayed content accordingly. Through the operation of the present disclosure, more contents can be showed a displaying device which size is limited. More precisely, as illustrated in FIG. 12, the display system 3 of the present disclosure displays a screen image A when the viewer looks from left to right. Through the operation of the present disclosure, as can be seen on the screen image A, the navigation map is dragged right, and the planned routes and vehicle information are showed at the right on the navigation map. Because of the effect, the displaying device 32 can therefore present additional geographic data and neighborhood information at the left-hand side.

In another example, as shown in FIG. 13, when the viewer changes his/her sightline to left from right, another screen image A is then presented to the viewer. Specifically, when the viewer looks to the left, the navigation map is move left as well, and the planned routes and other vehicle information are showed on the left-hand side. Consequently, the displaying device 32 is able to display more contents at the right-hand side.

Following the above example and as shown in FIG. 13, although the Building B is cut by the screen edge, however, under the operation of the present disclosure, the viewer may be able to get full information of the Building B so long as he/she turns the sightline toward right. It is noted that the orientation of the roads displayed on the map is adjusted according to the sightline of the viewer. Based on the above, the display system 3 of the present disclosure provides a more intuitive way to display additional contents according to the sightline of the viewer. Further, the present disclosure also provides a visual effect that is similar to the real-life experience. By applying these functions to navigation, the driver may recognize the direction easily, and moreover react intuitively and quickly whenever incidents happen.

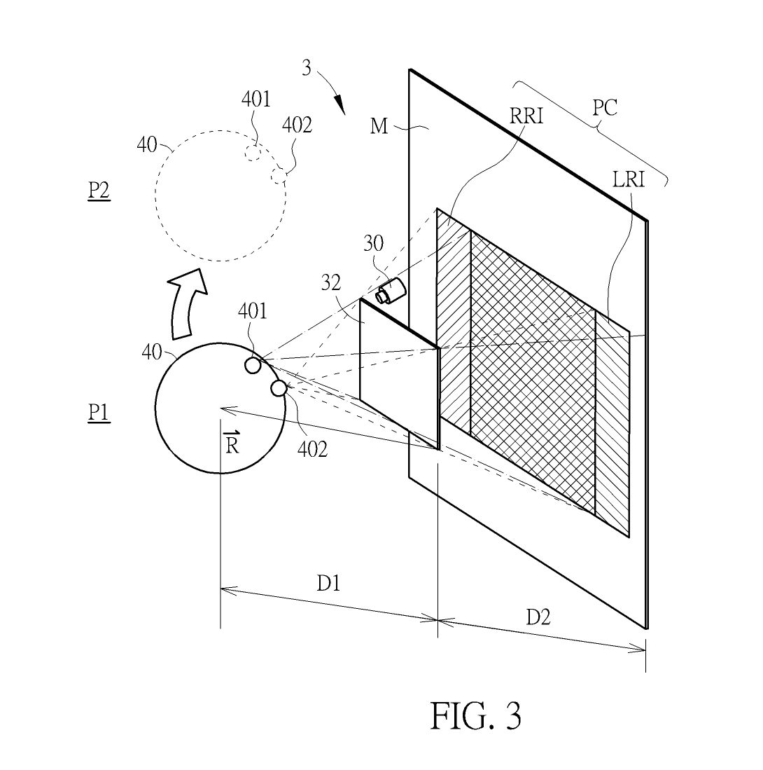

A system and a method for displaying images on the display system 3 is described as follows with reference to FIGS. 3-7. FIG. 3 is a diagram of the displaying system 3 of the present disclosure. As shown, the displaying system 3 may display images with depth (as the screen images of navigation map data shown in FIG. 12 and FIG. 13). When an image is presented on the displaying device 32, it appears to the viewer that a virtual space is inside the displaying device 32. Because of the effect, any virtual objects (such as the buildings, the traffic of cars, and the routes shown in FIG. 12 and FIG. 13) may appear in any positions of the virtual space in accordance with the viewer's sightline; consequently, the display system 3 can present additional information on the displaying device 32.

The relative positions of the viewer, the displaying device 32 and the displayed image M according to an embodiment of the present disclosure are also illustrated in FIG. 3. In this implementation, a viewer (e.g., the driver 4) is seated in a cabin 20 of the intelligent vehicle 1000, and his/her head faces toward the display system 3. The image capturing module 30 and the displaying device 32 are disposed in front of the viewer and facing toward the viewer. As shown, the distance between the viewer's head and the displaying device 32 is D1. In this implementation, the image M has depth information. According to the depth information, when the viewer views the displaying device 32, it appears to the viewer that the image M, instead of being located on the surface of the displaying device 32, is located on a plane in the virtual space behind the displaying device 32 with a distance D2. It should be noticed that the distance D2 is related to the depth information of the displayed image M.

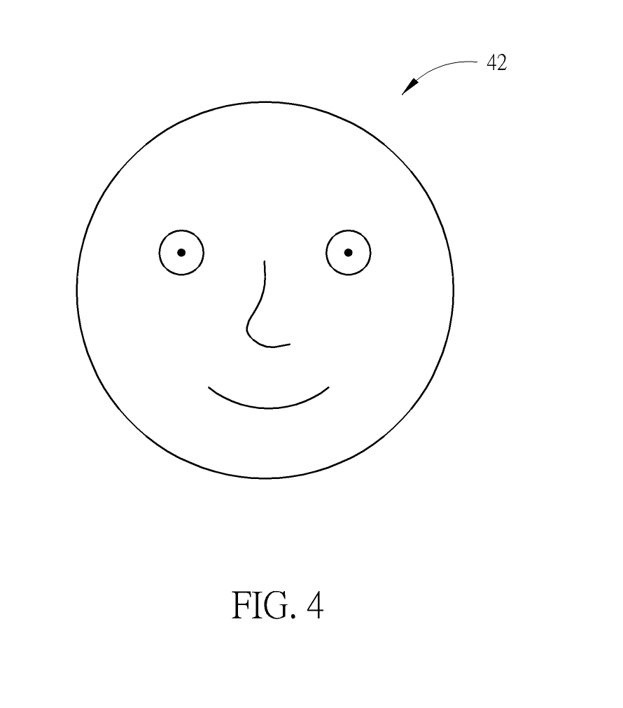

Firstly, the image capturing module 30 captures a head image 42 of the viewer's head 40. FIG. 4 is a schematic diagram of a head image 42 of the viewer captured by the image capturing module 30 according to an embodiment of the present disclosure.

In this embodiment, a coordinate system is established by the processing unit 34, where an origin of the coordinate system may be set at any point, and the position of the viewer is obtained and recorded with reference to the coordinate system. The processing unit 34 obtains the position (e.g., a head position or an eye position) of the viewer using 3D sensing technologies. For instance, the image capturing module 30 may be a stereo camera (with two or more lens) used for obtaining the position of the viewer. In some other implementations, the image capturing module 30 includes a depth sensor used for obtaining the position of the viewer.

Since the image capturing module 30 is a fixture on (or nearby) the displaying device 32, and the viewer is seated in the cabin 20, a position of the image capturing module 31 is known and invariant. The position of the cabin 20 is also known to the processing unit 34. Therefore, based on the positions of the image capturing module 30 and the viewer, the processing unit 34 computes a head vector R from the viewer's head 40 to the displaying device 32. The head vector R indicates a position of the viewer's head 40 and includes the distance D1 between the viewer's head 40 and the displaying device 32.

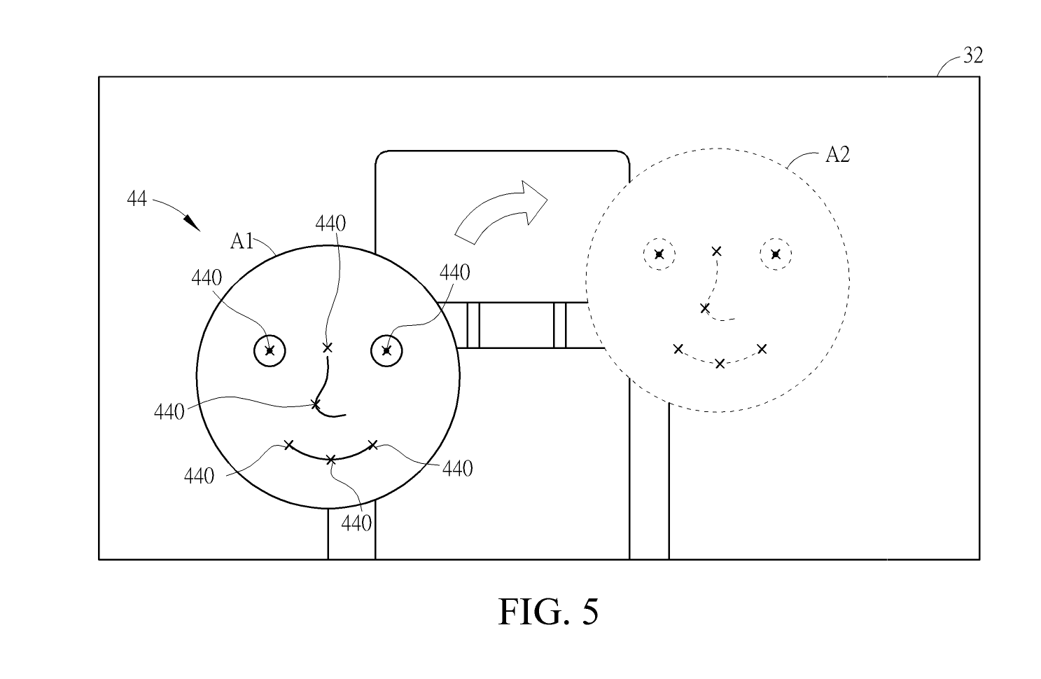

Based on the head image 42 shown in FIG. 4, at least one facial feature 440 is identified by the processing unit 34. FIG. 5 is a schematic diagram of a facial image 44 corresponding to the captured head image 42 (as shown in FIG. 4) according to an embodiment of the present disclosure. As shown in FIG. 5, the processing unit 34 identifies facial feature 440 based on the facial image 44. In one implementation, the facial image 44 is established by the processing unit 34 based on the head image 42. In another implementation, the facial image 44 is captured by the image capturing module 30. The facial feature 440 may be identified via computations of image recognition and image processing familiar by skilled persons. The facial feature may include, but not limited to, the positions of a left pupil, a right pupil, a nose tip, a middle point between the eyes, a forehead, the eyebrows, mouth, jar. In this embodiment, the facial feature 440 includes a left eye position and a right eye position. In some embodiments, the facial feature 440 further includes a head position. In yet another embodiment, the facial feature 440 further includes a head pose. The head pose includes an angle of yaw rotation, an angle of pitch rotation and an angle of a roll rotation. In some embodiments, the facial feature 440 further includes an eye gesture, which is determined, for instance, by the positions of the pupils, the positions of eyelids. It is noted that the processing unit 34 may determine the sightline of the viewer by analyzing variation of the facial feature 440 on various facial images 44.

Next, the processing unit 34 computes a left eye position and a right eye position of the viewer based on the facial image 44.

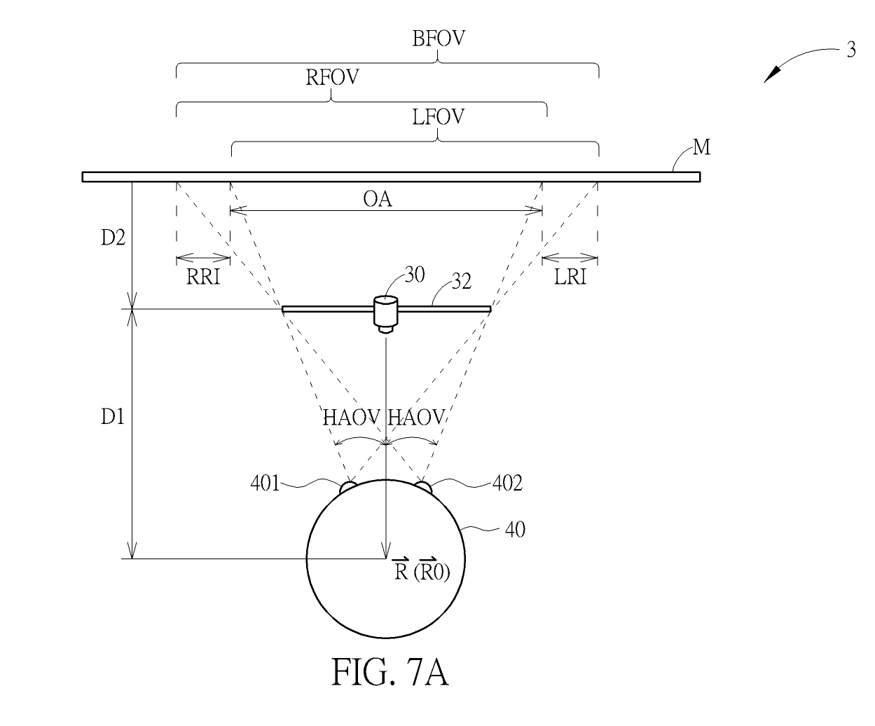

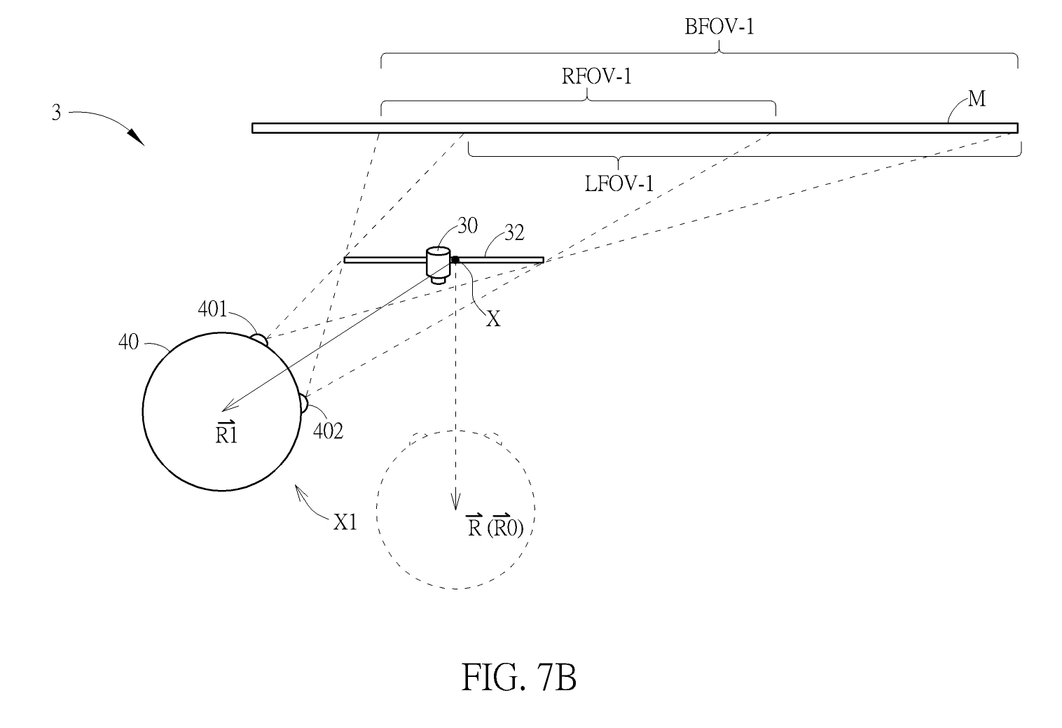

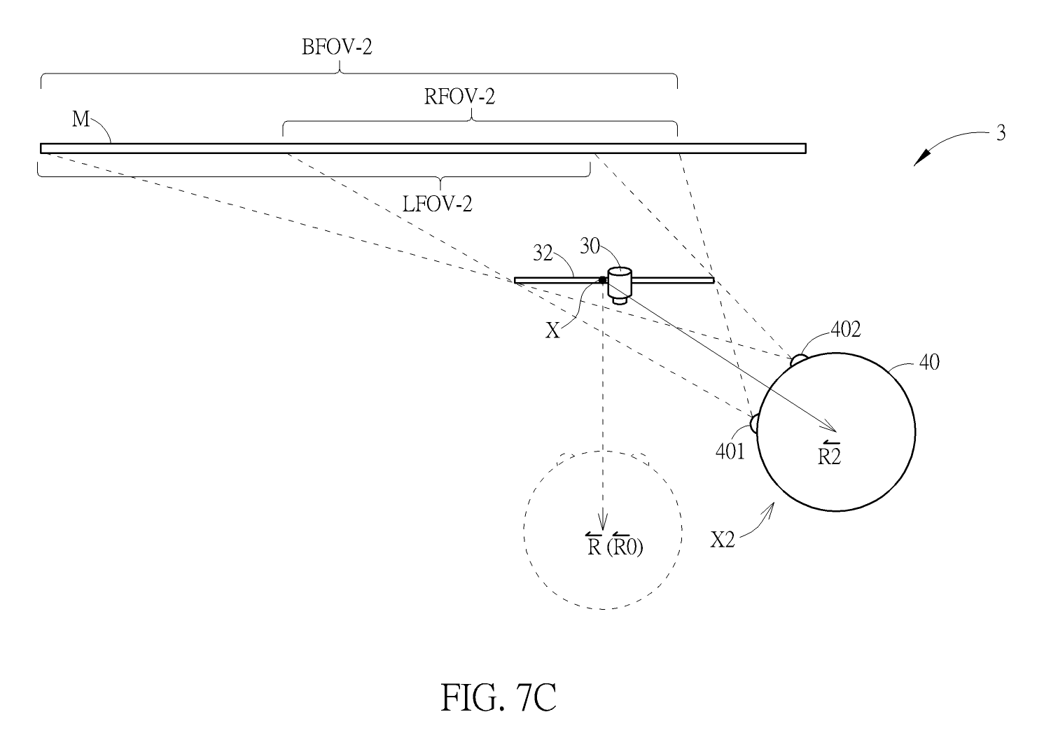

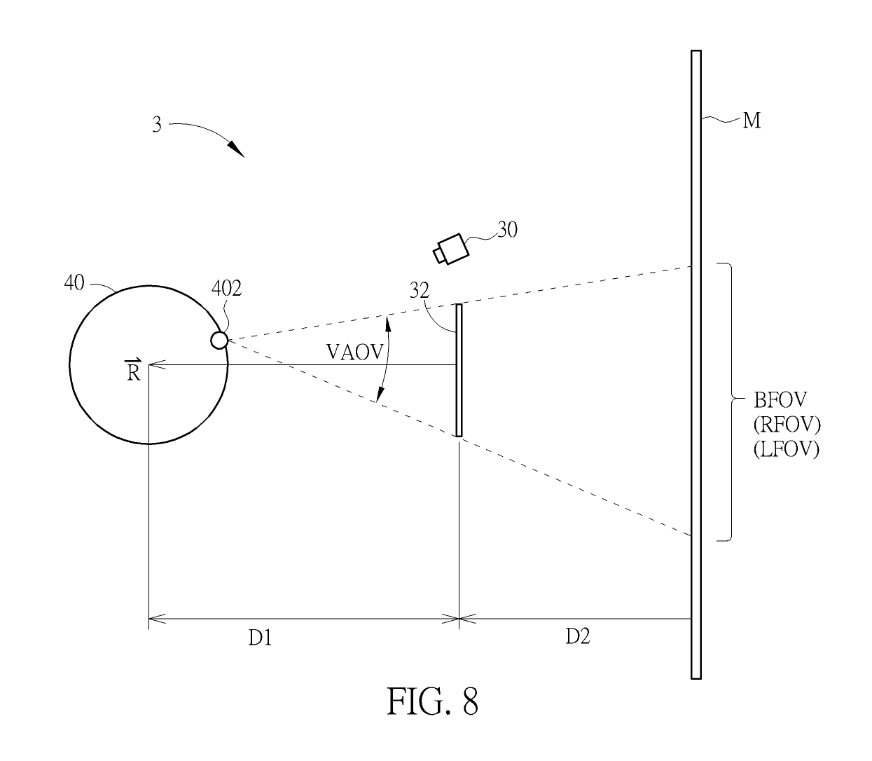

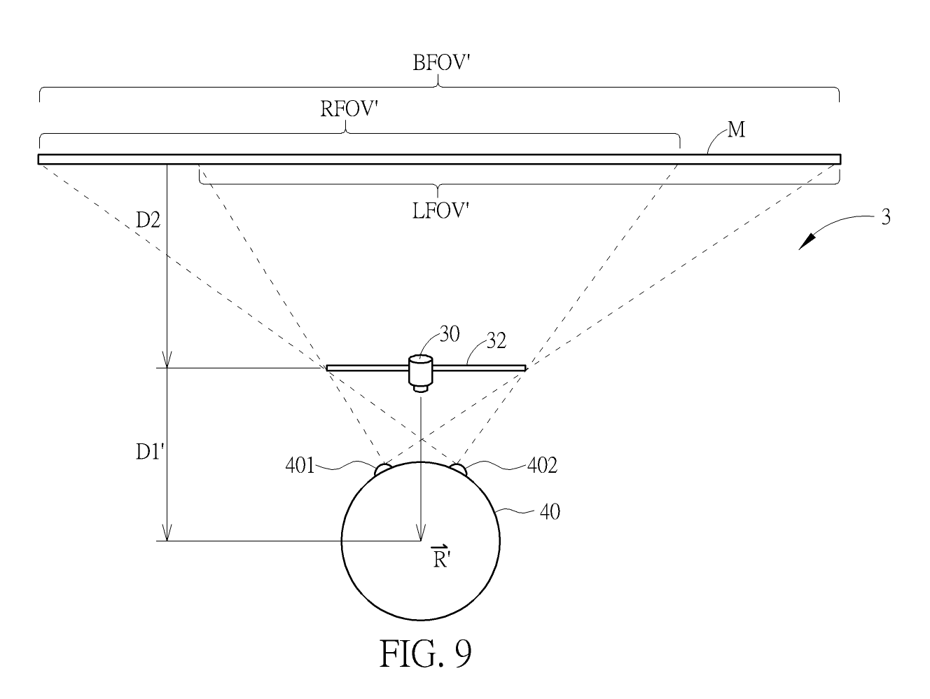

Next, the processing unit 34 generates a left eye field of view LFOV, a right eye field of view RFOV and the binocular stereoscopic field of view BFOV based on the head vector R, the left eye position and the right eye position. FIG. 7A is a schematic diagram illustrating the generation of a left eye field of view LFOV, a right eye field of view RFOV and the binocular stereoscopic field of view BFOV. Specifically, the left eye field of view LFOV and the right eye field of view RFOV are established based on a human's horizontal angle of view HAOV, a human's vertical angle of view VAOV (as shown in FIG. 8), the distance D1 between the head 40 and the displaying device 32, and the distance D2 between the displayed image M and the displaying device 32. For example, as shown in FIG. 7A, the left eye field of view LFOV is generated by expanding the horizontal angle of view HAOV of the human eyes from the position of the left eye toward to the plane where the image supposed to be displayed in the virtual space behind the displaying device 32 with a distance D2. Similarly, the right eye field of view RFOV is generated by expanding the horizontal angle of view HAOV of the human eyes from the position of the right eye toward to the plane in the virtual space behind the displaying device 32 with a distance D2 where the image is supposed to be displayed. And the binocular stereoscopic field of view BFOV is the combination of the left eye field of view LFOV and the right eye field of view RFOV.

In addition, the processing unit 34 computes a left eye rendered image LRI based on the left eye field of view LFOV, and a right eye rendered image RRI based on the right eye field of view RFOV. And then, the processing unit 34 computes the image PC (as shown in FIG. 3) based on the left eye rendered image LRI and the right eye rendered image RRI.

In one implementation where the display system 3 is applied to a navigation, the display system 3 may include a database configured to store geographic data and information. The display system 3 may acquire, from the database, the geographic data and information according to the sightline of the viewer and display the corresponding contents on the displaying device 32. In another implementation, only parts of the geographic data and information are stored in the database. When any geographic data and information is required to be shown on the displaying device 32, the processing unit 34 may perform real-time computation to obtain the necessary content and display thereof.

As shown in FIG. 7A, the left eye field of view LFOV and the right eye field of view RFOV overlap with each other to form an overlapping region OA. Besides, other than the overlapping region 43, the left eye field of view LFOV further includes the left eye rendered image LRI, while the right eye field of view RFOV further includes the right eye rendered image RRI. An image fusion processing may be performed on the overlapping region OA. Additionally, the left eye rendered image LRI and the right eye rendered image RRI are preserved. Therefore, the processing unit 34 computes the image PC based on the left eye rendered image LRI and the right eye rendered image RRI. Lastly, the displaying device 32 displays the image PC in the binocular stereoscopic field of view BFOV.

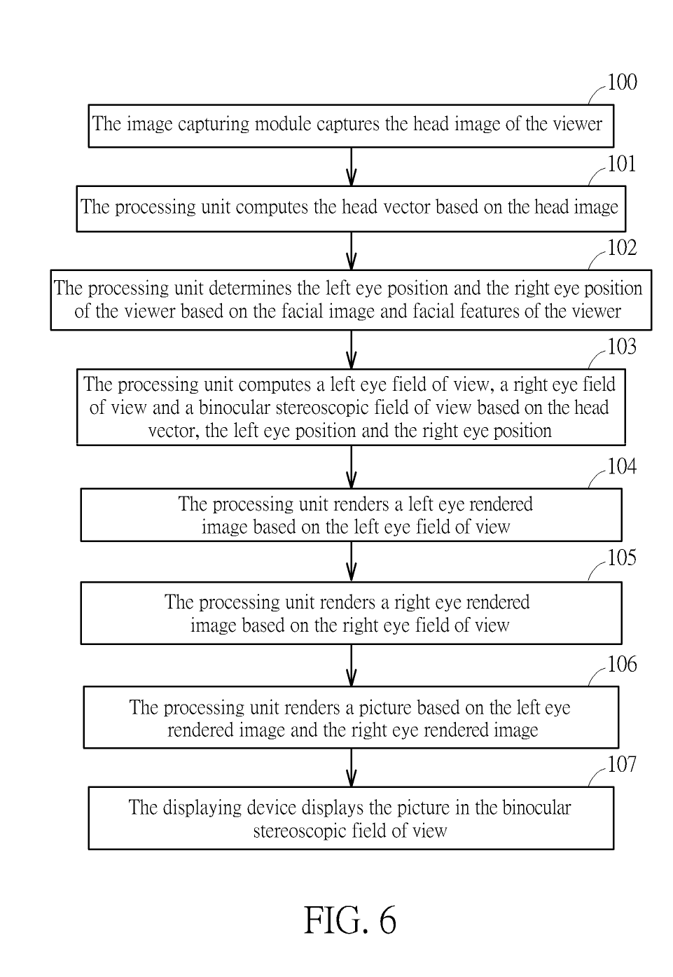

FIG. 6 is a flowchart illustrating a method for displaying images according an embodiment of the present disclosure. The method includes the following actions.

In action S100, the image capturing module 30 captures a head image of the viewer.

In action S101, the processing unit 34 computes a head vector R based on the head image.

In action S102, the processing unit 34 computes a left eye position and a right eye position of the viewer based on the facial image and facial features of the viewer. The facial image is obtained from the head image by the processing unit 34 or captured by the image capturing module 30.

In action S103, the processing unit 34 generates a left eye field of view, a right eye field of view and a binocular stereoscopic field of view based on the head vector, the left eye position and the right eye position.

In action S104, the processing unit 34 computes a left eye rendered image based on the left eye field of view.

In action S105, the processing unit 34 computes a right eye rendered image based on the right eye field of view.

Inaction S106, the processing unit 34 computes an image based on the left eye rendered image and the right eye rendered image.

In action S107, the displaying device 32 displays the image in the binocular stereoscopic field of view.

In another embodiment, the display system 3 of the present disclosure may provide various display contents according to the sightline of the viewer. In one implementation, the sightline of the viewer may be determined according to the position of the viewer's head 40 (e.g., represented by the head vector R). In some implementations, the sightline of the viewer may be determined according to the viewer's facial features. For example, the display system 3 may perform image processing on the captured head image 42 and facial image 44 to obtain the positions of the viewer's head 40, the viewer's left eye 401 and the viewer's right eye 402. Accordingly, the processing unit 34 computes a left eye field of view LFOV, a right eye field of view RFOV and renders an image PC for the displaying device 32 to display thereon. As iterated, the image PC is presented in the viewer's binocular stereoscopic field of view BFOV corresponding to the positions of the head 40, the left eye 401 and the right eye 402.

Since the image capturing module 30 is a fixture on (or nearby) the displaying device 32, a capturing angle and a capturing range of the image capturing module 30 for capturing images is invariant. Therefore, the head image 42 or the facial image 44 captured by the image capturing module 30 varies with different positions of the viewer.

For example, as shown in FIG. 3, when the viewer shifts from a first position P1 (marked by the solid lines) to a second position P2 (marked by the dashed lines), the facial image 44 also changes, as shown in FIG. 5, from the first position A1 (marked by the solid lines) to the second position A1 (marked by the dashed lines). In one embodiment, the head movement or motion may be sensed by the image capturing module 30 or some other sensors disposed on, for instance, a headrest on the driver's seat. Therefore, based on the captured facial image 44, the processing unit 34 computes a distance between the viewer and the displaying device 32 when the viewer is at the position P2. In some other embodiments, the processing unit 34 further determines the head movement of the viewer, such as yaw rotation, pitch rotation and a roll rotation, based on the variation of the facial feature 440 on the facial image 44.

FIGS. 7A-7C are schematic diagrams illustrating images displayed under three different scenarios according to different positions of the viewer. First of all, as shown in FIG. 7A, when the viewer is at a first position looking straight toward the displaying device 32, an image is displayed in the first binocular stereoscopic field of view BFOV. Specifically, the image capturing module 30 captures a first head image of the viewer and the processing unit 34 computes a first head vector \vec{R0} based on the first head image. The processing unit 34 further computes a first left eye position 401 and a first right eye position 402 based on a first facial image. Afterward, and the processing unit 34 computes a first left eye field of view LFOV, a first right eye field of view RFOV and a first binocular stereoscopic field of view BFOV based on the first head vector \vec{R0}, the first left eye position 401 and the first right eye position 402. Next, the processing unit 34 computes a first left eye rendered image LRI based on the first left eye field of view LFOV, and a first right eye rendered image RRI based on the first right eye field of view RFOV. Next, the processing unit 34 computes a first image PC based on the first left eye rendered image LRI and the first right eye rendered image RRI. Subsequently, the displaying device 32 displays the first image PC with depth information (a distance D2).

On the other hand, as shown in FIG. 7B, when the viewer moves his/her head to the left (e.g., a second position X1) and turn his/her sightline toward the right, another image is displayed in the second binocular stereoscopic field of view BFOV-1. More specifically, the image capturing module 30 captures a second head image of the viewer. The processing unit 34 determines that the head position of the viewer has moved left and therefore computes the second head vector \vec{R1} based on the second head image. Next, the processing unit 34 computes a second left eye position 401 and a second right eye position 402 based on a second facial image. Afterward, and the processing unit 34 computes a second left eye field of view LFOV-1, a second right field of view RFOV-1 and a second binocular stereoscopic field of view BFOV-1 based on the second head vector \vec{R1}, the second left eye position 401 and the second right eye position 402. Next, the processing unit 34 computes a second left eye rendered image based on the second left eye field of view LFOV-1 and a second right eye rendered image based on the second right eye field of view RFOV-1 (not labelled in FIG. 8B). Next, the processing unit 34 renders a second image PC based on the second left eye rendered image and the second right eye rendered image, and the displaying device 32 displays the second image in the second binocular stereoscopic field of view BFOV-1.

It should be noted that, the position of the image capturing module 30 is selected to be the origin of the coordinate system referenced in the display system 3 for computing the displacement vector (i.e., a distance and a direction of the movement of the viewer). In some other embodiments, the displacement vector may not only include x component but also y and/or z components when the viewer moves his/her head forward/backward and/or upward/downward.

Based on the above, assuming the viewer is in a first position at a first time (as shown in FIG. 7A) and then moves to a second position at a second time (as shown in FIG. 7B), the displaying device 32 will accordingly changes the images displayed thereon. Specifically, the displaying device 32 displays a first image in the first binocular stereoscopic field of view BFOV when the viewer is in the first position, and it displays a second image in the second binocular stereoscopic field of view BFOV-1 when the viewer is in the second position. Because of the positional change, a pan displacement between the first image and the second image occurs. It should be noted that in effect the pan displacement can be regarded as a displacement between the first binocular stereoscopic field of view BFOV and the second binocular stereoscopic field of view BFOV-1.

Alternatively, as shown in FIG. 7C, assuming the viewer moves right to a second position X2 and turn his/her sightline toward left, a further another image is displayed in the third binocular stereoscopic field of view BFOV-2. Specifically, the image capturing module 30 captures a third head image of the viewer. The processing unit 34 determines that the head position of the viewer has moved right, and subsequently obtains the third head vector \vec{R2} based on the third head image. Next, the processing unit 34 computes a third left eye position 401 and a third right eye position 402 based on a third facial image. Afterward, and the processing unit 34 computes a third left eye field of view LFOV-2, a third right field of view RFOV-2 and a third binocular stereoscopic field of view BFOV2 based on the third head vector \vec{R2}, the third left eye position 401 and the third right eye position 402. Next, the processing unit 34 computes a third left eye rendered image based on the third left eye field of view LFOV-2, and a third right eye rendered image based on the third right eye field of view RFOV-2 (not labelled in FIG. 7C). Next, the processing unit 34 computes a third image PC based on the third left eye rendered image and the third right eye rendered image. The displaying device 32 therefore displays the third image PC in the third binocular stereoscopic field of view BFOV-2.

To sum up, the display system 3 of the present disclosure visually establishes a virtual space. In effect, when the viewer moves left and turns his/her sightline to right, the viewer observes the right corner of the virtual space. In addition, when the viewer moves right and turns his/her sightline to left, the viewer observes the left corner of the virtual space. By utilizing the virtual space, the display system can not only display additional contents despite the size limitation of a screen, but also changes the contents in accordance with the perspectives of the viewer. In one implementation, the abovementioned display system and the method may be applied to a navigation including geographic data and information. In one instance, when the viewer is at the second position X1 and watches the displaying device 32 as illustrated in FIG. 7B, the image therefore rendered is as depicted in FIG. 12. Moreover, in another occasion, if now the viewer is at the third position X2 and watches the displaying device 32 as illustrated in FIG. 7C, the image therefore rendered is as shown in FIG. 13.

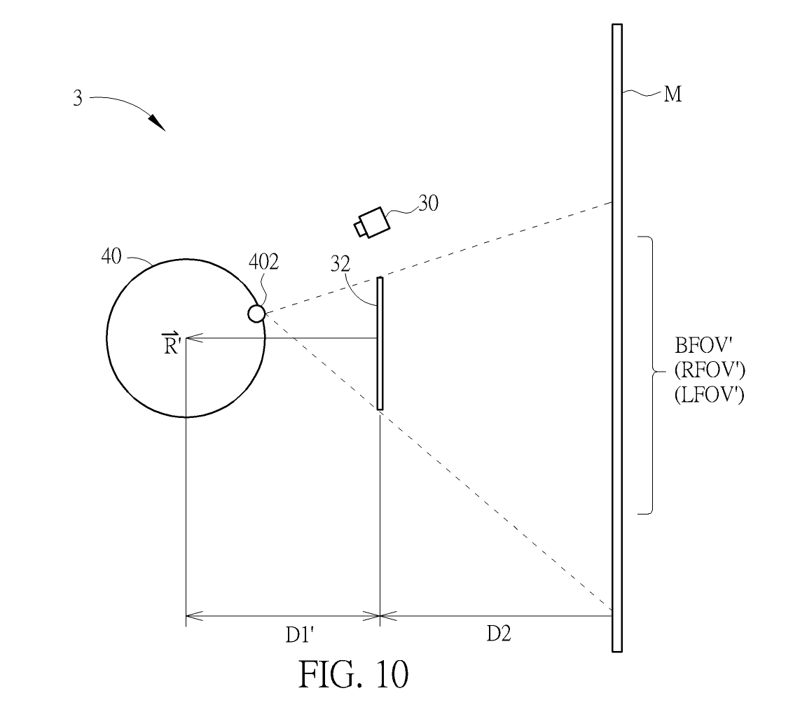

In some embodiments, the viewer may zoom in or zoom out on the displayed image. FIGS. 8-10 illustrate the examples. In one instance, as shown in FIG. 8, assuming the distance between the viewer and the displaying device 32 is D1. Then, the viewer moves close to the displaying device 32. As shown in FIGS. 9 and 10, the distance between the viewer and the displaying device 32 is now D1′. Because the current distance D1′ between the viewer and the displaying device 32 is smaller, the ranges of left eye field of view LFOV′, the right eye field of view RLOV′, and the binocular stereoscopic field of view BFOV′ are all enlarged. As a result, a bigger image may be achieved and displayed on the displaying device 32. Similarly, if the viewer is moving away from the displaying device 32 and therefore increase the his/her distance to the displaying device 32, the ranges of left eye field of view, the right eye field of view, and the binocular stereoscopic field of view will all be reduced. Consequently, the image therefore can be displayed is much smaller. To sum up, by changing the position toward and/or backward the displaying device 32, the viewer can easily either adjusting the size the displayed image.

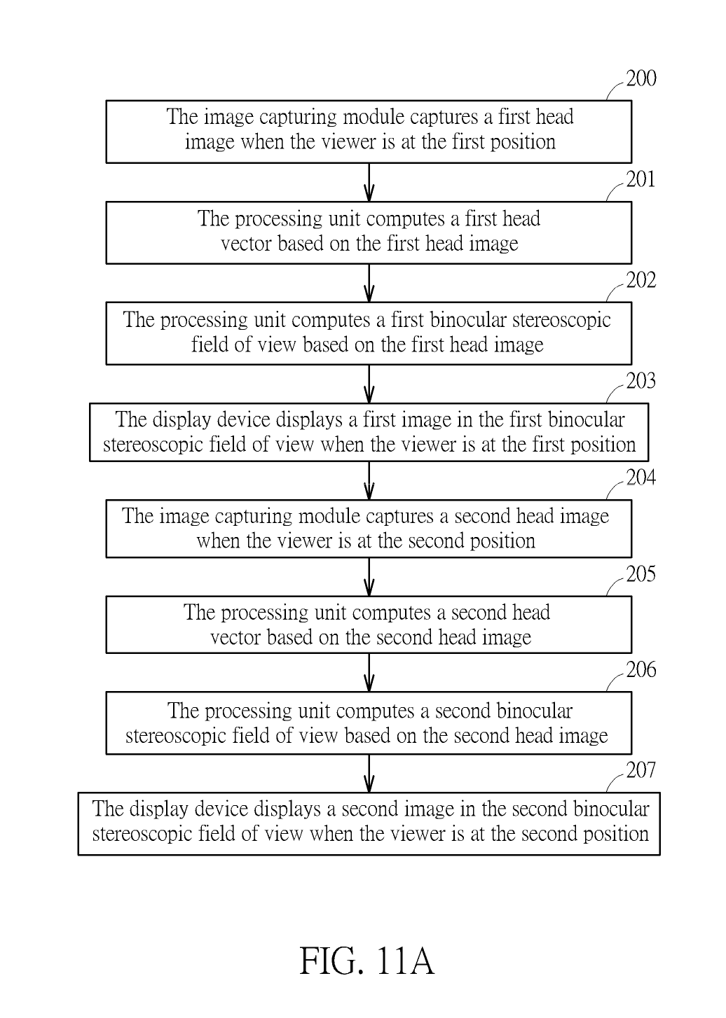

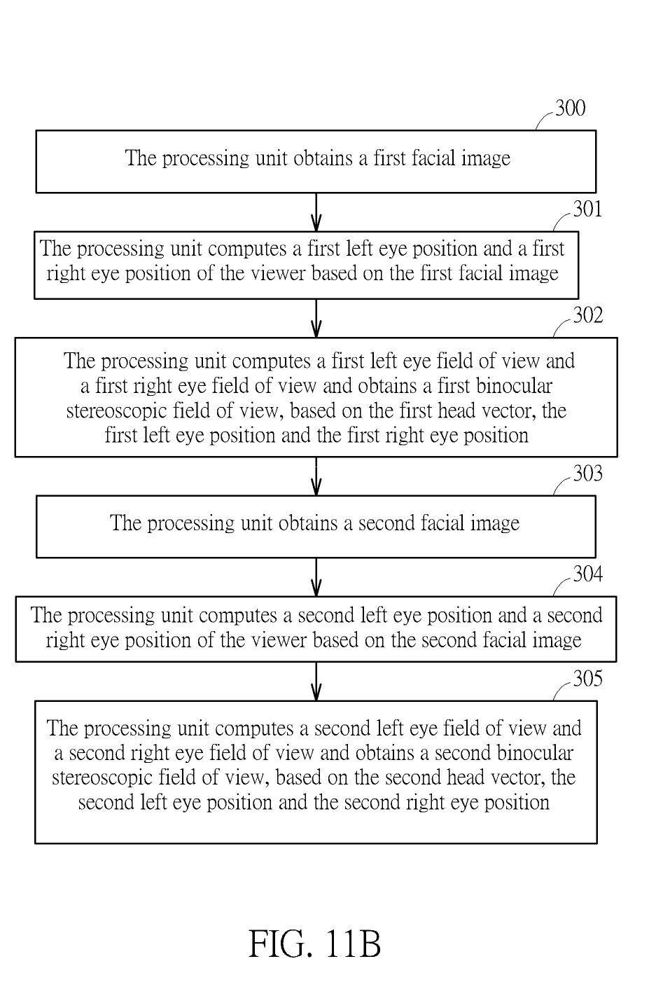

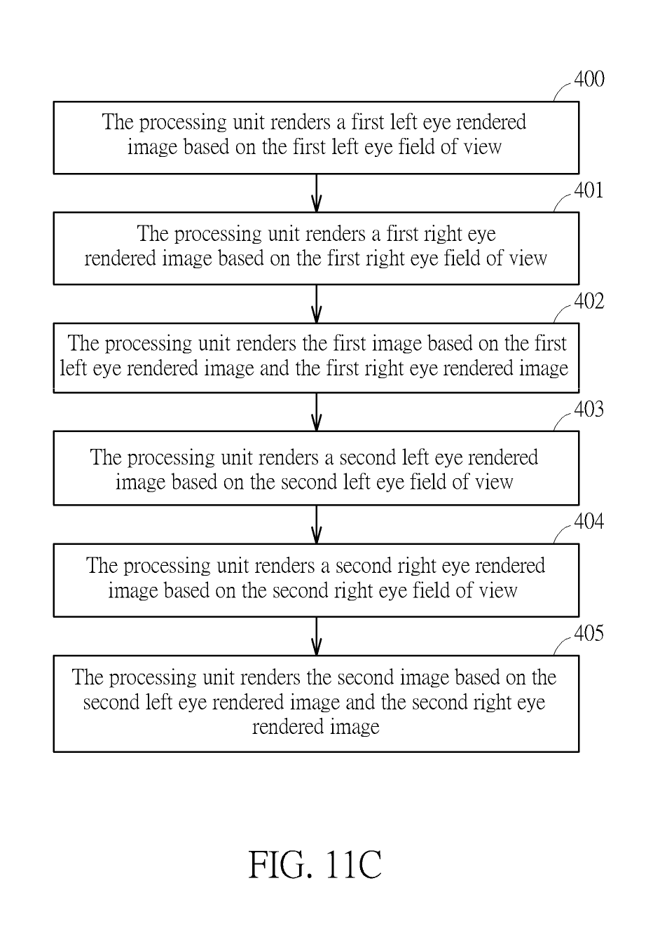

FIG. 11A is a flowchart illustrating a method for displaying various images in accordance with the sightlines of the viewer. The method includes the following actions.

In action S200, the image capturing module 30 captures a first head image when the viewer is at the first position.

In action S201, the processing unit 34 computes a first position of the viewer. For instance, the first position is represented by a first head vector based on the first head image, where the first head vector includes a first distance between the viewer's head and the displaying device 32.

In action S202, the processing unit 34 computes a first binocular stereoscopic field of view based on the first head image.

In action S203, the displaying device 32 displays a first image in the first binocular stereoscopic field of view when the viewer is at the first position.

In action S204, the image capturing module 30 captures a second head image when the viewer is at the second position.

In action S205, the processing unit 34 computes a second position of the viewer. For instance, the second position is represented by a second head vector based on the second head image, where the second head vector includes a second distance between the viewer's head and the displaying device 32.

In action S206, the processing unit 34 computes a second binocular stereoscopic field of view based on the second position.

In action S207, the displaying device 32 displays a second image in the second binocular stereoscopic field of view when the viewer is at the second position.

In some embodiments, the first position and the second position are further determined according to a left eye position and a right eye position of the viewer. In this embodiment, the method further includes the procedure as shown in FIG. 11B. The method further includes the following actions.

In action S300, the processing unit 34 obtains a first facial image, where the first facial image is obtained from the first head image or captured by the image capturing module 30.

In action S301, the processing unit 34 computes a first left eye position and a first right eye position of the viewer based on the first facial image.

In action S302, the processing unit 34 computes a first left eye field of view and a first right eye field of view based on the first head vector, the first left eye position and the first right eye position; and the processing unit 34 obtains a first binocular stereoscopic field of view, which is the combination of the first left eye field of view and the first right eye field of view.

In action S303, the processing unit 34 obtains a second facial image, where the second facial image is obtained from the second head image or captured by the image capturing module 30.

In action S304, the processing unit 34 computes a second left eye position and a second right eye position of the viewer based on the second facial image.

In action S305, the processing unit 34 computes a second left eye field of view and a second right eye field of view based on the second head vector, the second left eye position and the second right eye position; and the processing unit 34 obtains a second binocular stereoscopic field of view, which is the combination of the second left eye field of view and the second right eye field of view.

In some other embodiments, the method further includes procedures as shown in FIG. 11C to adjust the display contents according to the sightline of the viewer. The method further includes the following actions.

In action S400, the processing unit 34 computes a first left eye rendered image based on the first left eye field of view.

In action S401, the processing unit 34 computes a first right eye rendered image based on the first right eye field of view.

In action S402, the processing unit renders the first image based on the first left eye rendered image and the first right eye rendered image.

In action S403, the processing unit 34 computes a second left eye rendered image based on the second left eye field of view.

In action S404, the processing unit 34 computes a second right eye rendered image based on the second right eye field of view.

In action S405, the processing unit renders the second image based on the second left eye rendered image and the second right eye rendered image.

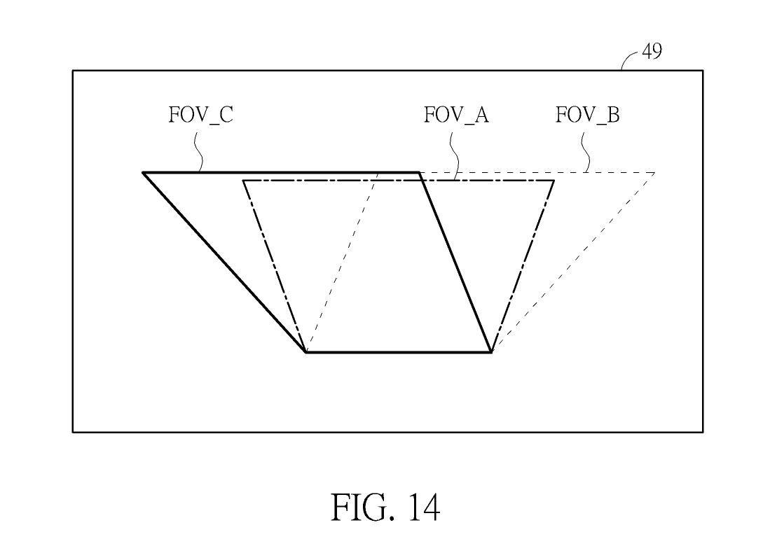

Based on the above, by implementation of the parallax between the left and right eyes, the range of the field of view may be increased. FIG. 14 is a schematic diagram of a virtual space 49 when the displayed images varies in accordance with the sightlines of the viewer according an embodiment of the present disclosure. Specifically, a virtual space 49 in vision is generated by the display system 3 in this disclosure, and an image is displayed in the virtual space (e.g., the field of view FOV_A) when the viewer looks ahead. When the viewer moves left (or turns the sightline right), the viewer observes the right corner of the virtual space 49 from the left (e.g., the field of view FOV_B). Similarly, when the viewer moves right (or turns the sightline left), the viewer observes the left corner of the virtual space 49 from the right (e.g., the field of view FOV_C).

Based on the above, through the operation of the virtual space, the displaying device of the present disclosure is able to display additional contents that conventional screen cannot achieved. For example, by simply changing the sightline, the viewer may observe more contents on a 12.3″ screen without performing complicated operations manually.

The display system of the present disclosure may capture a head image of the viewer, compute a binocular stereoscopic field of view based on the head image, and display an image in the binocular stereoscopic field of view accordingly. Therefore, the display system of the present disclosure displays images in accordance with the human binocular vision. Moreover, the display system of the present disclosure renders images based on different positions of the viewer; each of the images rendered corresponds to the relative position between the viewer and the displaying device.

The above actions are discussed in order but the present disclosure may also be achieved by the same steps with a different order, or by additional steps.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display system, comprising:
an image capturing module configured to capture a head image of a viewer; and
a processing unit coupled to the image capturing module, the processing unit being configured to:
compute a head vector based on the head image, wherein the head vector comprises distance information between the viewer and the display device;
compute a left eye position and a right eye position of the viewer based on a facial image of the viewer;
generate a left eye field of view and a right eye field of view based on the head vector, the left eye position and the right eye position;
generate a binocular stereoscopic field of view based on the left eye field of view and the right eye field of view; and
a displaying device coupled to the processing unit, and configured to display an image in the binocular stereoscopic field of view.

2. The display system of claim 1, wherein the processing unit is further configured to obtain the facial image based on the head image.

3. The display system of claim 1, wherein the image capturing module is further configured to obtain the facial image.

4. The display system of claim 1, wherein the processing unit is further configured to:
compute a left eye rendered image in the left eye field of view;
compute a right eye rendered image in the right eye field of view; and
render the image based on the left eye rendered image and the right eye rendered image;
wherein an image fusion processing is performed on an overlapping part of the left eye field of view and the right eye field of view, while a non-overlapping part of the left eye field of view and the right eye field of view is preserved in the image.

5. The display system of claim 1, wherein if a value of the distance information decreases, a range of the binocular stereoscopic field of view increases; while if the value of the distance information increases, the range of the binocular stereoscopic field of view decreases.

6. A display system, comprising:
an image capturing module configured to capture a first head image of the viewer when the viewer is at a first position, and capture a second head image of the viewer when the viewer is at a second position; and
a processing unit coupled to the image capturing module, the processing unit being configured to:
compute a first head vector of the viewer at the first position based on the first head image;
obtain a first facial image of the viewer and compute a first left eye position and a first right eye position of the viewer based on the first facial image;
generate a first left eye field of view and a first right eye field of view based on the first head vector, the first left eye position, and the first right eye position;
generate a first binocular stereoscopic field of view based on the first left eye field of view and the first right eye field of view;
compute a second head vector of the viewer at the second position based on the second head image;
obtain a second facial image of the viewer and compute a second left eye position and a second right eye position of the viewer based on the second facial image;
generate a second left eye field of view and a second right eye field of view based on the second head vector, the second left eye position, and the second right eye position;
generate a second binocular stereoscopic field of view based on the second left eye field of view and the second right eye field of view;
a display device coupled to the processing unit, and configured to display a first image in the first binocular stereoscopic field of view when the viewer is at the first position, and displays a second image in the second binocular stereoscopic field of view when the viewer is at the second position.

7. The display system of claim 6, wherein the first facial image and the second facial image is established by the processing unit based on the first head image and the second head image, respectively.

8. The display system of claim 6, wherein the first facial image and the second facial image is captured by the image capturing module.

9. The display system of claim 6, wherein the first head vector comprises first distance information between the viewer and the display device, and the second head vector comprises second distance information between the viewer and the display device.

10. The display system of claim 6, wherein the processing unit is further configured to:
compute a first left eye rendered image in the first left eye field of view;
compute a first right eye rendered image in the first right eye field of view;
render the first image based on the first left eye rendered image and the first right eye rendered image;
compute a second left eye rendered image in the second left eye field of view;
compute a second right eye rendered image in the second right eye field of view; and
render the second image based on the second left eye rendered image and the second right eye rendered image;
wherein an image fusion processing is performed on an overlapping part of the first left eye field of view and the first right eye field of view, while a non-overlapping part of the first left eye field of view and the first right eye field of view is preserved in the first image; and
wherein an image fusion processing is performed on an overlapping part of the second left eye field of view and the second right eye field of view, while a non-overlapping part of the second left eye field of view and the second right eye field of view is preserved in the second image.

11. The display system of claim 10, further comprising:
a database configured to store data of the first left eye rendered image, the first right eye rendered image, the second left eye rendered image, and the second right eye rendered image.

12. The display system of claim 6, wherein each of the first image and the second image is a map including geographic data and information, and the first image and the second image both have first geographic data and information.

13. The display system of claim 6, wherein when a distance between the viewer at the first position and the display device is greater than a distance between the viewer at the second position and the display device, a range of the first binocular stereoscopic field of view is less than a range of the second binocular stereoscopic field of view.

14. A method for displaying a navigation map including geographic data and information, comprising:
storing the geographic data and information in a database;
determining a first position of the viewer;
displaying, by a displaying device, a first image including a first geographic data and information when the viewer is at the first position;
displaying, by the display device, a second image including a second geographic data and information upon determining that the viewer has moved from the first position to a second position.

15. The method of claim 14, wherein the first position and the second position is determined according to a head position, a left position and a right eye position of the viewer.

16. The method of claim 14, further comprising:
generating a first left eye field of view, a first right eye field of view and a first binocular stereoscopic field of view when the viewer is at the first position, wherein the first binocular stereoscopic field of view is a combination of the first left eye field of view and the first right eye field of view; and
generating a second left eye field of view, a second right eye field of view and a second binocular stereoscopic field of view when the viewer is at the second position, wherein the second binocular stereoscopic field of view is a combination of the second left eye field of view and the second right eye field of view.

17. The method of claim 16, further comprising:
computing a first left eye rendered image based on the first left eye field of view of the viewer and the first geographic data and information;
computing a first right eye rendered image based on the first right eye field of view of the viewer and the first geographic data and information; and
rendering the first image based on the first left eye rendered image and the first right eye rendered image.

18. The method of claim 16, further comprising:
computing a second left eye rendered image based on the second left eye field of view of the viewer and the second geographic data and information;
computing a second right eye rendered image based on the second right eye field of view of the viewer and the second geographic data and information; and
rendering the second image based on the second left eye rendered image and the second right eye rendered image.

19. The method of claim 14, wherein when a distance between the viewer at the first position and the display device is greater than a distance between the viewer at the second position and the display device, the second image is displayed as an enlarged view of the first image.

20. The method of claim 14, wherein when the second position is on the left of the first position, the second image comprises more geographic data and information of the right-hand side.

21. The display method of claim 14, wherein when the second position is on the right of the first position, the second image comprises more geographic data and information of the left-hand side.
